(19) United States
(12) Patent Application Publication
(10) Pub. No.: US 2022/0139122 A1
(43) Pub. Date: May 5, 2022

(54) METHOD FOR MONITORING A FUNCTIONALITY OF A VEHICLE INFORMATION SYSTEM OF A MOTOR VEHICLE, AND ELECTRONIC COMPUTING DEVICE, COMPUTER PROGRAM AND DATA CARRIER

(71) Applicant: DAIMLER AG, Stuttgart (DE)

(72) Inventors: Micha KOLLER, Pliezhausen (DE); Hubert REHBORN, Sindelfingen (DE); Frank STARMAN, Boeblingen (DE)

(21) Appl. No.: 17/430,498

(22) PCT Filed: Feb. 4, 2020
(86) PCT No.: PCT/EP2020/052758

§ 371 Date: Aug. 12, 2021

(30) Foreign Application Priority Data
Feb. 14, 2019 (DE) 10 2019 001 100.7

(51) Int. Cl. G07C 5/00; G07C 5/08

(52) U.S. Cl. CPC G07C 5/008; G07C 5/0808

(57) ABSTRACT

A method for monitoring a functionality of a vehicle information system of a motor vehicle, which functionality is requested via an interface from a device external to the vehicle and extends the functional scope of the vehicle information system, and whose at least one functionality property is defined based on a framework condition plan stored in a register is provided. The functionality is requested via the interface, and the functionality is executed by the vehicle information system. An operating state of the functionality of the vehicle information system is detected and compared with the functionality property recorded in the framework condition plan. When there is a deviation of the operating state from the functionality property recorded in the framework condition plan, at least one value characterising the deviation for the register and/or at the interface of the vehicle information system is provided.

### BACKGROUND AND SUMMARY OF THE INVENTION

Exemplary embodiments of the invention relate to a method for monitoring a functionality of a vehicle information system of a motor vehicle, an electronic computing device, by means of which a method for monitoring the functionality of a vehicle information system can be carried out, a computer program, by means of which a method for monitoring a functionality of a vehicle information system can be executed on an electronic computing device, and a data carrier comprising a computer program product and/or, when used in an electronic computing device, can perform a method for monitoring a functionality of a vehicle information system.

In order for a vehicle information system, which can perform assistance functions, for example by means of telematics, of a motor vehicle, in particular of a motor vehicle designed as a passenger car, to be able to provide a particularly wide range of functions, respective functionalities, the totality of which can comprise the range of functions, are frequently provided by different suppliers. A functionality can thus represent a service, or in particular a service provision, such as a navigation function, for example. By way of example, a service provider can offer a service and/or data required for the service by means of a device which is, for example, a computing device or computing center, which can be transferred to and/or used by the vehicle information system. In order for the functionality to function as desired by a user of the vehicle information system, at least one agreement can be made between the provider and the supplier of the motor vehicle and/or the user of the vehicle information system. This agreement can describe at least one functionality property. The functionality property can comprise, for example, a quality of service by which, for example, the availability and/or at least one further quality feature of the functionality are prescribed. This can be done, for example, by means of a service level agreement, i.e., a framework agreement that includes the functionality properties. In addition, conditions can be defined for non-compliance with the functionality properties thus guaranteed, which must be fulfilled if the functionality property is not complied with. If the service level agreement is, for example, the aforementioned framework agreement, the non-compliance conditions can be defined, for example, in the form of a contractual penalty.

By way of example, if a navigation function for the vehicle information system provided by the provider is not provided as expected or as assured by the functionality property, navigation cannot be performed properly. The fulfilment of the non-compliance condition or non-fulfilment condition can turn out to be difficult to enforce. By way of example, the user of the vehicle navigation system would have to arrange for feedback that the navigation function was not available at a given time or did not function as desired to be sent to the provider. The provider would then have to take note of this, verify it if necessary and, in addition, the provider is in a position to make a claim that the navigation function worked at the time complained about according to its monitoring of the functionality. Enforcing the non-fulfilment condition is thus often a manual process, which is substantially bureaucratic or complicated and takes some time.

One possibility to enforce the non-compliance condition automatically is outlined in Technical Report No. FIF-2018.02 of April 2018 by the University of Zurich, entitled “Automatic SLA compensation based on smartphone tracks”. Here, the functionality property, in particular in the form of a service level agreement, is recorded in a data-processable manner and monitored by means of a computer system.

From the financial sector, for example, in particular in the field of cryptocurrency, such as Bitcoin or Ethereum, the concept of a blockchain is known. Such a blockchain, which can be understood as a register, in particular as a distributed register, in which data can be written, in particular in a row, creates a system which can guarantee the integrity of the data, for example, both to a provider and to a user.

WO 2018/006056 A1 shows a method involving the method of a blockchain-based letter of credit in relation to a contract for a commercial transaction between a seller and a buyer. Here, the blockchain-based letter of credit defines payment trigger events for a document and supply chain flow.

Exemplary embodiments of the present invention are directed to a method, an electronic computing device, a computer program product, and a data carrier, by means of which a functionality of a vehicle information system of a motor vehicle can be monitored, such that a deviation of an actual operating state of the vehicle information system caused by the functionality relative to a functionality property and thus a target operating state can be detected.

A first aspect of the invention relates to a method for monitoring a functionality, which can, for example, represent or comprise a service or a function, of a vehicle information system, which for example comprises a driver assistance system and/or an infotainment system, of a motor vehicle, which in particular can be designed as a passenger car. In the method according to the invention, the functionality, and/or in particular data required for the functionality, is requested via an interface from a device external to the vehicle, and the functional scope of the vehicle information system is expanded. The device can be, for example, at least one electronic computing device, in particular in the form of a server, which executes a program or a service or provides the program and/or data required for execution via the interface, which is provided, for example, in the form of a radio modem. The functionality can thus be or comprise, for example, a service and/or a program and/or data for executing the service and/or the program. By way of example, the functionality can also be formed as a module of the vehicle information system and thereby execute a navigation function, for example. At least one functionality property, which characterizes an operating state of the vehicle information system that can be achieved by the functionality and is particularly advantageous for the functionality, of the functionality is defined on the basis of a framework condition plan stored in a register, which in particular can represent a memory area of at least one electronic computing device. The framework condition plan is thus substantially a contract stored in a manner that can be digitally processed or processed by information technology, which comprises at least the functionality property describing the manner in which the functional scope of the vehicle information system is extended, in particular by the vehicle information system being placed by the functionality in an operating state extending the functional scope. In other words, the functionality property characterizes a desired operating state that can be achieved by the vehicle information system by means of the functionality, or the functionality property characterizes the desired operating state of the functionality.

The method according to the invention for monitoring the functionality of the vehicle information system has several steps:

In a first step, a request for the functionality is made via the interface. The functionality can be requested, for example, in the form of the program, the service and/or the data required, in particular for carrying out the functionality, wherein the corresponding form can be specified depending on the functionality. Here, a request initiated by the vehicle information system can be made via the interface to the device, which likewise has a corresponding interface for this purpose, such that a communication between the vehicle information system and the functionality and device is enabled, for example via a mobile radio network. Based on the demand or request, the device provides the functionality, for example in the form of a service such as vehicle navigation. In particular, the device can be designed as a so-called backend and can have, for example, at least one computing device connected to an information network, such as the Internet, in particular a server. The functionality can thus be obtained by the vehicle information system from the device.

In a second step of the method according to the invention, an execution of the functionality is performed by the vehicle information system. During execution, the vehicle information system is set to an operating state in which the functional scope of the vehicle information system is extended, for example by making available the vehicle navigation corresponding to the functionality.

In a third step of the method, the operating state, in particular the actual operating state, of the functionality of the vehicle information system is recorded. This means that information is recorded which characterizes the functionality, for example the vehicle navigation, in particular in such a way that the actual operating state can be derived from this information. By recording the operating state, it can be determined whether the functionality properties stored or saved in the framework condition plan, which in particular characterize the functional scope of the vehicle information system, which is extended by the functionality, are being observed. If, for example, the direction information required for navigation is output with a delay, this is detected by detecting the operating state.

In a fourth step of the method, the operating state, in particular the detected operating state, is compared with the functionality property recorded in the framework condition plan, which substantially characterizes a target operating state of the functionality and thus a target operating state of the vehicle information system. The comparison thus determines differences or deviations between the target operating state defined by the recorded functionality property and the actual operating state of the vehicle information system. If, for example, the delay in the direction information of the functionality designed as vehicle navigation is recorded and this is, for example, a specific time X, which is in particular greater than a deviation of a time Y defined by the functionality property in the framework condition plan, and thus in particular permitted, this is determined on the basis of the comparison performed by the method.

In a fifth step of the method, in the event of a deviation of the operating state from the functionality property recorded in the framework condition plan, at least one value characterizing the deviation is provided for the register and/or at the interface of the vehicle information system. The deviation determined by the comparison is thus assigned a value which, for example, describes the magnitude of the deviation as, for example, the difference between the time X and the time Y, is generated. The value can thus be, for example, a simple value, but, for example, the value could comprise at least one parameter and/or a variable or similar. This value is now provided by means of the method in such a way that it is available at the interface of the vehicle information system and/or for the register, such that it can be transmitted or communicated to the device via the interface, for example, or can be written in the register, for example. The value makes it possible to designate the deviation representing, for example, a malfunction or a restricted range of functions, making it possible to obtain, in particular automatically, a measure of the quality of the functionality and thus to check whether the conditions defined and thus assured in the framework condition plan are met by the functionality, for example the assured properties for vehicle navigation.

An information system such as the vehicle information system is substantially a system having the object of meeting information demands, so it is a system which, for example, produces, procures, distributes, and/or processes data, whereby, for example, an effect on the operation of the motor vehicle is possible.

Advantageously, the register is based on distributed ledger technology, i.e., the register is mirrored in at least one register image i.e., there is one, in particular identical, copy of the register, the register image. In this case, virtually any number of register images can be made, wherein the register and the register image are in particular identical and thus undistinguishable. By way of example, the register can be stored on the vehicle information system and the register image can be stored on the device, for example, or vice versa. Further register images are stored, for example, on further devices which are in each case different from the device or the vehicle information system, wherein the largest possible number of devices, which in each case hold or store the register or the image, is particularly advantageous, for example, for protection against forgery of the register, since a change that is made only in one of the registers or the register images is recognizable in comparison with the other registers or register images that have not been changed.

Depending on the design of the information stored in the register, for example, in particular the functionalities or the framework condition plan having the functionalities and/or the at least one value, the register together with its register images can thus be designed as a blockchain.

The framework condition plan is advantageously designed as a computer program and/or computer protocol which, for example in the form of an algorithm, has means for checking the scope of functionality predetermined based on the at least one functionality property and possible deviations from this scope, which are desired to the maximum extent, in particular by the user who has requested the functionality via the interface using the vehicle information system. The framework condition plan can thus substantially be designed as a smart contract. In other words, the framework condition plan is advantageously a computer protocol that can depict and/or check contracts or agreements, in particular between the device and the vehicle information system regarding the functionality, and technically support the implementation of the contract, i.e., the execution of the functionality, in particular in light of the functionality property. The functionality property thus effectively describes a framework condition, in particular for a recurrently retrievable functionality.

In other words, the functional properties define a service level agreement, in which promised performance properties such as, for example, a performance scope of the functionality, for example, response time and speed of processing in the case of vehicle navigation, for example, are described in detail. An important component of the functionality properties is an agreed performance quality and thus a described performance spectrum, for example time or scope, within which, for example, vehicle navigation is available.

The invention is based on the realization that, in order to provide services or functionalities in vehicle information systems, it is often necessary to obtain data or functionalities from providers that are not the provider of the vehicle information system. Agreements on the quality of service are made with these providers, in particular for example suppliers, which are recorded in particular in the functionality properties and prescribe, for example, the availability and other quality features. In addition, conditions are defined, for example in the form of so-called contractual penalties, which become due if the provider does not or cannot comply with the agreements. These agreements, including contractual penalties, can be agreed in particular between the provider of the vehicle information system and another provider or supplier. In addition, an agreement can also be made between the supplier and the user of the vehicle information system. To ensure that the contractual penalty contained in the respective agreement is enforceable, monitoring is advantageous for each individual agreement in particular. Until now, the monitoring of the functionality properties has been carried out, if at all, by means of at least predominantly manual control and, furthermore, the contractual penalties have also been demanded manually. However, both are usually particularly time-consuming and bureaucratic, such that contractual penalties are often waived in the event of non-fulfilment of functionality. An electronically available framework condition plan, in particular in the form of a smart contract, which is formed by the computer protocol and/or the computer program or by an algorithm to be carried out on the basis thereof, is a possibility created to automatically monitor the functionality properties, in particular on the basis of the at least one value. Furthermore, the agreed deviation fulfilment or contractual penalties can also be initiated or enforced, in particular automatically.

Each functionality could, for example, be offered by its own provider, such that the vehicle information system requests the respective functionality from the respective provider in the first step of the method according to the invention. In order to now enable a particularly advantageous monitoring of the entirety of the functionalities and thus of each individual one of the functionalities, a respective framework condition plan and thus at least one respective functionality property is defined with the respective provider.

Furthermore, the invention is based on the realization that an array of cryptocurrencies, such as Bitcoin or Ethereum, offers the possibility of also processing framework conditions plans. Thus, the possibility is created that, due to the blockchain used for the cryptocurrencies or the distributed register, the framework condition plan can be stored due to the register images, in particular, for example, publicly, and advantageously cannot be manipulated, as already outlined above. Thus, there is no longer a need for a central entity that controls, for example, the functionality properties agreed in the framework condition plan, in particular in the smart contract, whereby a trust level between, for example, the provider and the user can be particularly low. By way of example, in contracting based on smart contacts and further using blockchain technologies, the cumbersome and bureaucratic process of enforcing contractual penalties, in particular such as service level agreements, which may be analogous to the functionality properties, is dispensed with.

The method according to the invention also provides this possibility for monitoring the functionality of the vehicle information system, such that, for example, personnel can be saved on in a particularly advantageous way, which is required, for example, to record, evaluate, and initiate responses to manually executed feedback messages about a malfunction or a deviation from the target operating state of the vehicle information system, since the method according to the invention can programmatically record and automate this process. Furthermore, the method according to the invention has the advantage that a unilateral change of the framework condition plan can be excluded, for example by the user of the vehicle information system and/or the provider or operator of the device. This means that the vehicle information system can be operated particularly reliably, since the operating state can be predicted particularly well for a period of time to be specified by the user of the vehicle information system.

In other words, the method according to the invention enables, for example, service-specific monitoring of providers, so-called content providers, with or by means of smart contracts, wherein the motor vehicle is connected to a device and at least one service, i.e., the functionality in the vehicle information system, is implemented based on data or services of the content provider. The functionality can comprise, for example, a traffic information service, petrol station prices, a parking service, and/or similar. In addition, other services or functionalities can also be used in the vehicle information system, for example audio services, video offers, voice services, and/or similar. The method according to the invention is thus characterized by the fact that, by means of the smart contract, the automatic monitoring of a service level for a service provider of the vehicle information system takes place, for example for a traffic service provider depending on the vehicle navigation provided by it. The framework condition plan determines, for example, what is to be monitored, for example, an interface, such that services accessible via the Internet that are provided by the device or accessed directly by the motor vehicle in order to obtain the service, for example the functionality, can be monitored. Furthermore, a definition of threshold values with respect to the functionality properties can occur, for example. Here, for example, a threshold value is defined stating the degree to which agreed parameters, such as minimum availability, in particular online availability of URI and/or URL of 99.99 percent and/or the maximum response time of 100 milliseconds, are to be complied with. The availability and/or the response time are determined for each functionality or service to be monitored and an interface used for this purpose, which is carried out in particular in step 3 of the method. In step 4, the determined values for the availability and the response time are compared with the contractually agreed threshold values for each monitored interface or functionality, and finally, on the basis of the value determined in step 5, the triggering of a payment for the differentiation of the defined respective threshold value is initiated, such that, for example, for a response time that is greater than 100 milliseconds, a fee of 1 euro can be sent to the vehicle information system, or the manufacturer of the vehicle information system, and/or its user.

In an advantageous design of the invention, the value is transmitted, in particular via the interface, at least to the device and/or another device which respectively maintains the register and/or the register image. In other words, by means of the method, the value characterizing the deviation of the operating state is offered to an instance that comprises or has available, or stores in a memory region, a version in the form of the register or its image. This results in the advantage that the value can be retrieved in addition to the vehicle information system on the device and/or a further device, which is connected, for example by means of a data network, to the device and/or the vehicle information system, such that monitoring of the functionality is made possible in a decentralized manner. The device is, for example, an electronic computing device that can be part of a Cloud environment, in particular in the form of a server. However, a private personal computer of the user of the vehicle information system can also function as the further device, for example, such that the value can be retrieved at as many different locations as possible, depending on where the device and/or the further device and/or the vehicle information system are located.

In a further advantageous design of the invention, the value, in particular encrypted, i.e., encrypted by a cryptographic method such as a hash method, is entered into the register and/or the register image and thus in particular into the entirety of the registers, in particular as a block or part of a block. In other words, depositing the value in the register is done in analogy to depositing a value in a blockchain, i.e., the block is in particular added to the register, such that the register is expanded by the value, thereby increasing the content of the register and thus the register itself. The encrypting can be carried out, for example, by means of a key that occurs in the vehicle information system, in particular a private-public key method (private-public key) and thus with an asymmetric cryptographic method, as a result of which the value can be entered in the register in such a way that it can be uniquely assigned to the vehicle information system. Advantageously, the value is also provided with a time stamp, such that it can also be assigned over time. In this case, if the value is stored as a block, this is done in the form of a data block, such that the data block is a block of the blockchain and thus of the register, which is updated over time in such a way that a linking of successive blocks takes place. Advantageously, when the value is stored in the block, a hash value of all blocks already in the register is generated by means of a cryptographic method as well, in particular by means of a hash function, such that the newly generated block can be unambiguously assigned to the blockchain at a specific point in time on the basis of the blocks stored before it. Thus, advantageously, in addition to the value in the block, the hash value formed by a hash function from a previously stored block is also stored, which precludes subsequent manipulation of the value, at least in the event that the manipulator does not obtain control over a majority of the facilities. Furthermore, encrypting the value itself, in particular for example by means of a private key of the vehicle information system, makes it possible to prove in a forgery-proof manner that the vehicle information system generated the value.

In an advantageous design of the invention, the value is entered depending on a consensus agreement. In other words, the value or the new block is not entered in the register until there is agreement, in particular between the device and/or the further device and/or the vehicle information system, that the value is legitimately generated. This has the advantage that protection against forgery and thus enforceability in the event of non-fulfilment of the functional scope, i.e., the non-compliance condition, can be carried out with particular certainty. Furthermore, this ensures that all entities involved in the blockchain (facility, further facility, vehicle information system), which have thus all stored the register or a register image, can maintain an identical image of the register. In this context, the consensus agreement or the consensus method is ensured, for example, by the existence of a proof of claim, for example in the form of a proof of stack, whereby it is regulated that one of the participants, for example the vehicle information system, may write the value in the register and thus generate the next block of the blockchain. Furthermore, so-called validators can also be used for the consensus method. This is fundamentally a computer program that can check a syntactical correctness of files.

In a further advantageous design of the invention, the value is further compared with a value table stored in the framework condition plan, in which a deviation operation, in particular a non-compliance condition, is described for at least the value. The value table is designed, for example, in such a way that a corresponding deviation operation is defined for a corresponding value that lies within a specific value range, which deviation operation describes what is to be carried out by the device and/or the vehicle information system on the basis of the deviation which is characterized by the value, in order, for example, to improve the actual operating state and/or to provide compensation for the deviation.

In a further advantageous design of the invention, the deviation operation is performed depending on the provided value. By way of example, an extension for the useful life may be considered if a functionality has not been available for a certain time or during a certain time. This is recorded in the value table that determines the deviation operation, wherein the deviation operation can thus be performed by the method. By way of example, in the case of vehicle navigation, if this is down, it could be agreed by the value table that, if the period of use comprises, for example, one day, this is extended by one day. Alternatively, or additionally, there are manifold possibilities as to how the non-compliance condition or deviation operation can be interpreted. By way of example, it could be that, if the response time of, for example, a server request to the device obtained by the functionality is too high, an amount, for example of a cryptocurrency, is to be paid to the vehicle information system. In other words, the value table or the comparison list, respectively, can bring about the violation of the contract condition defined in the functionality property in the framework condition plan in the register. Thus, in an advantageous way, it is possible to initiate the actions for an improvement of the operational condition that are possible on the basis of the performed monitoring and/or to provide a corresponding counterpart. Thus, in a particularly advantageous way, the procedure can be carried out automatically.

In a further advantageous design of the invention, the framework condition plan is changed depending on the value entered in the register, i.e., in particular the block and/or depending on change instructions stored in particular in the framework condition plan. Thus an, in particular dynamic, adaptation of the functionality property is possible. Therefore, by means of further information stored in the framework condition plan, such as the value table, for example, it is possible to react dynamically to certain circumstances, for example influences, which impair the functionality, such that in particular the functional scope of the vehicle information system can be kept as large as possible in accordance with the circumstances without offering disadvantages for the device and/or the user of the vehicle information system.

A second aspect of the invention relates to an electronic computing device, in particular of the vehicle information system, for example, which is designed to carry out a described method.

In this regard, the electronic computing device can also comprise a plurality of instances which are connected, for example, by means of a computer-to-computer connection (peer-to-peer connection (P2P), wherein in particular each of the instances maintains the register. Alternatively, the computing device is one of the instances.

A third aspect of the invention relates to a computer program product according to the invention, which implements a method according to the invention on an electronic computing device. In particular, the computer program product can be in the form in which it is directly loadable into a memory or memory region of the electronic computing device. The computer program product has program means that are present in particular in the form of instructions which, when executed on the electronic computing device, cause the latter to carry out the method according to the invention.

A fourth aspect of the invention relates to a computer-readable data carrier. The data carrier according to the invention comprises control information stored thereon, which comprises at least the computer program product according to the invention and/or is configured in such a way that, when the data carrier is used in an electronic computing device, a method according to the invention is carried out.

The properties and developments of the method according to the invention as well as the corresponding advantages specified so far and in the following are each transferable analogously to the electronic computing device according to the invention and/or to the computer program product according to the invention and/or the data carrier according to the invention, and vice versa.

Furthermore, the invention comprises a motor vehicle having a device, such as the electronic computing device, suitable for carrying out the method according to the invention.

Further advantages, features and details of the invention emerge from the following description of a preferred exemplary embodiment and from the drawing. The features and combinations of features mentioned above in the description, as well as the features and combinations of features mentioned below in the description of figures and/or shown alone in the figures, can be used not only in the combination specified in each case, but also in other combinations or on their own, without departing from the scope of the invention.

### BRIEF DESCRIPTION OF THE DRAWING FIGURES

Here are shown:

FIG. 1 a schematic flow diagram of a method for monitoring a functionality of a vehicle information system of a motor vehicle; and

FIG. 2 schematic representation of the motor vehicle comprising the vehicle information system in interaction with a device external to the vehicle, as well as a register which can be held as a register image in the device and/or the vehicle information system.

### DETAILED DESCRIPTION

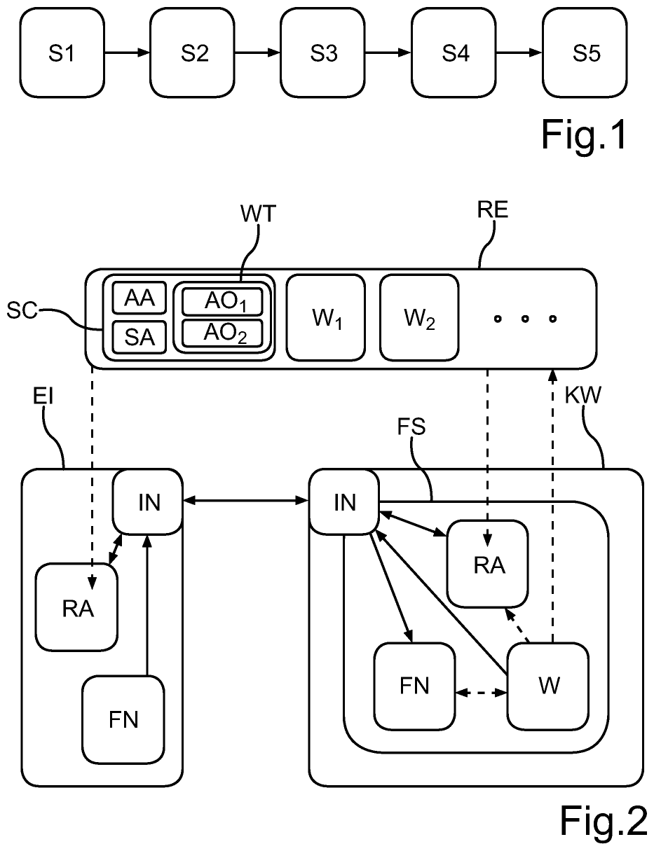

In the schematic flow diagram, FIG. 1 shows a method for monitoring a functionality FN of a vehicle information system FS of a motor vehicle KW, which is designed, in particular, as a passenger car or another form of motor vehicle. For the method, the functionality FN is requested via an interface IN from a device EI external to the vehicle. The functionality FN extends the functional scope of the vehicle information system FS. At least one functionality property SA, in particular in the form of a service level agreement, of the functionality FN is defined on the basis of a framework condition plan SC stored in a register RE, in particular in the form of a smart contract.

In order to perform the monitoring of the functionality FN particularly advantageously, the method comprises several steps:

In a first step S1 of the method, a request for the functionality FN is made via the interface IN. In a second step of the method S2, the functionality FN is executed by the vehicle information system FS. In particular, the vehicle information system FS is designed in such a way that it is, for example, a system comprising a driver assistance system and/or, for example, an infotainment system and a telematics unit, wherein the functionality FN can, for example, provide an assistance function of the driver assistance system. In a third step S3 of the method, an operating state, in particular an actual operating state, of the functionality FN of the vehicle information system FS is detected. During the acquisition of the operating state, information is acquired that indicates the state of the functionality FN, for example in the form of the functions performed by it, in the vehicle information system FS. In a fourth step S4 of the method, the operating state is compared with the functionality property SA recorded in the framework condition plan SC, which in particular characterize a target operating state. In a fifth step S5 of the method, in the event of a deviation of the detected operating state from the functionality property SA recorded in the framework condition plan SC, a value W characterizing the deviation is provided for the register RE and/or the interface IN of the vehicle information system FS.

In FIG. 2, an interaction relationship between the motor vehicle KW or its vehicle information system FS with the at least one device EI is shown, and furthermore, in the upper region of FIG. 2, the register RE is shown with its components, such as, for example, the framework condition plan SC, which contains and defines the functionality property SA.

The framework condition plan SC in the form of the smart contract is substantially a computer protocol that, in particular, automatically checks whether the functionality property SA or, for example, the execution of a deviation operation AO stored in a value table WT and thus a non-compliance condition is carried out. Thus, by means of the method, a possibility of monitoring can be provided, since the performance characteristics assured with the device EI for compliance with functionality property SA in the form of the service level agreement, such as a performance scope, a response time and/or similar, and furthermore a maximum permitted deviation from the assured performance scope can be defined, which should be complied with by the functionality FN.

So that the method can be carried out in a particularly advantageous manner, the value W is transmitted at least to the device EI, in particular via the interface IN and/or a further device, which is not shown, which in each case holds the register RE and/or a register image RA. Here, the register image RA is virtually an identical copy or version, in particular a digital copy, of the register RE, such that the register image RA and the register RE are indistinguishable. By distributing the register RE or the register image RA to at least the device EI or the vehicle information system FS, it is not possible for one of the instances, the device EI and/or the vehicle information system FS, to manipulate its version of the register RE or its register image RA, for example the framework condition plan SC stored therein, without noticing the difference when comparing it with the corresponding register image RA of the other instance. This virtually rules out any manipulation of the monitoring.

The probability of manipulation is further reduced by the fact that the value W is signed, in particular encrypted, in particular by a key of a key pair of the device EI and preferably of the vehicle information system FS. During the encryption, the value W can be added, in particular as a block or part of a data block, to the information already in the register RE, such as the framework condition plan SC or a value W1 already in the register, such that the register RE is extended in each case at least by the value W to be entered. Advantageously, a further value or parameter is entered in addition to the value W, in particular also advantageously encrypted by means of a hash function, which contains a summary, in particular as a hash value, of information previously in the register RE, thus further increasing the forgery protection of the register RE. To ensure that only permissible values W can be entered in the register RE or the register image RA, the value W is entered depending on a consensus agreement. Various consensus procedures are conceivable, for example a validator is used and/or a proof of state of one of the instances, i.e., the device EI and/or the vehicle information system FS, is performed. In addition, or furthermore, a proof of work is also possible, for example. This can further increase the security or the verification of the functionality FN.

Advantageously, the value W is compared with a value table WT stored in the framework condition plan SC, in which the non-compliance condition or the deviation operation AO is described for at least one value W1, which is to be performed in response to the deviation of the actual operating state of the functionality FN of the vehicle information system FS in comparison with the target operating state determined by the functionality SA. In this case, the deviation operation AO is advantageously performed depending on the value W provided.

Advantageously, the method can be carried out by an electronic computing device, which for example comprises the vehicle information system FS. Furthermore, the method can be carried out by a computer program product, in particular in a memory of the electronic computing device, wherein the computer program product comprises program means for this purpose, in particular instructions, which carry out the presented method on the electronic computing device. Furthermore, a computer-readable data carrier can contain these program means, which can be computer-readable by the electronic computing device, for example.

By means of the method, in particular service-specifically, i.e., depending on a provider which provides the functionality FN by the device EI, this provider can be monitored by the framework condition plan SC in the form of the smart contract. In this context, the provider can be a content provider, which is, for example, a provider of a vehicle navigation of an Internet access and/or another service provider. The functionality FN can thus in particular be a service, such as vehicle navigation, which is also referred to as a service. The device EI is advantageously a backend, in particular vehicle backend, which comprises at least one electronic computing device. Communication between the interface IN of the device EI designed as a backend takes place via a mobile radio with the interface IN of the vehicle information system FS. It is possible for the functionality FN, which is provided in the device EI, to comprise data whose provision to the vehicle information system FS expands the latter's functional scope, and/or the data are designed in such a way that they themselves expand the functional scope. If the functional scope is, as in the case of vehicle navigation, for example, a service such as a traffic information service, petrol station prices, a parking service and/or similar, this service can be used, in particular within the framework of the framework condition plan SC on the motor vehicle KW. In addition to assistance services such as the traffic information service, services for an infotainment system of the motor vehicle KW such as audio services, in the form of music streaming and/or similar, can also be provided.

The framework condition plan SC can also be used to monitor interfaces, for example, particularly if the functionality FN is an Internet service. Furthermore, a threshold value can be defined in the framework condition plan SC, in particular in its functionality property SA, which for example include agreed parameters such as the minimum availability of, for example, 99.99 percent and/or the maximum response time of a maximum of 100 milliseconds for the traffic service provider in response to a request by the vehicle information system FS. Furthermore, a definition, in particular in the form of the value table WT, can be provided in the framework condition plan SC in which, for example, a penalty payment is possible in the event of a violation of the contractual condition, i.e., in the event of non-compliance with the functional scope of the vehicle information system FS to be guaranteed by the functionality property SA. Here, corresponding monitoring can be carried out for one functionality FN at a time by executing the procedure several times, in particular in the case where the respective functionality FN can be obtained from a different provider in each case.

The different providers can, for example, each use their own and/or a common server, in particular as a vehicle backend and/or as a Cloud infrastructure, in order to be able to maintain all the functionalities FN provided for the vehicle information system FS. For the respective functionality FN, for example, the availability as well as the response time is determined. Furthermore, for each functionality FN, the determined values W for the availability and the response time are compared with the contractually agreed threshold values, i.e., the value W is compared with the value table WT. Depending on this value table WT, the deviation operation AO is then initiated. Different deviation operations AO can be recorded for different deviations, i.e., different values W, as shown for example in FIG. 2 by the index number of the respective deviation operations AOᵢ.

Advantageously, the register RE exists as a blockchain, whereby the framework condition plan SC is also part of the blockchain. This is stored, for example, by means of the criterion and/or a further protocol in the blockchain and thus in the register RE. Preferably, the storage takes place on as many devices EI or vehicle information systems FS and/or further devices as possible. The register RE can also contain several framework condition plans SC, for example, for a respective functionality FN or a respective provider of the functionality FN, whereby automated monitoring of all functionalities FN is thus possible by means of the register RE.

Advantageously, a provider of the functionality FN can pay a deposit, for example in the form of a security deposit, in the framework condition plan SC, for example in the form of a cryptocurrency, such that in the event of a deviation by the value W depending on the value table WT, for example as a deviation operation, an amount is transferred from the security deposit, which is stored in the framework condition plan SC, to the user of the vehicle information system FS and/or its manufacturer.

Here, regulated by the value table WT, the amount can depend on the severity of the violation, for example 100 Euro penalty if the actual availability is 99.8 and not the required 99.99 percent. The graduation can be such that, for example, a penalty of 1000 Euros is due if the actual availability is 99.7 percent.

Compliance with the functionality property SA, i.e., the service level agreement or the service level, can be signaled to the provider or the device EI automatically, for example, in addition to the register RE, by means of e-mail.

In addition to the availability of the functionality FN, the functionality property can also require and/or agree on further quality characteristics, for example a spatial-temporal reference, for example the number of GPS data for a certain period on a certain road for a traffic information service, or the up-to-dateness of petrol station prices in a region, and/or the availability, for example, of external audio sources during a journey can be part of the functionality SA.

If the quality features, which are governed in the functionality property SA, of a service provider have a temporal reference, for example, petrol station prices can vary, the deviation can also be specified in the functionality FN, then petrol station prices must be updated once per hour, otherwise a deviation operation AO occurs. For car park information, for example, it can be agreed that the car park occupancy must not be older than 30 minutes.

Furthermore, the quality features of a provider of the functionality FN can have a spatial reference. By way of example, on-street parking information may be more accurate and available in Stuttgart than in, say, Copenhagen, i.e., depending on the number of choices made by users of the vehicle information system.

Furthermore, quality characteristics may allow for certain weaknesses depending on the functionality FN, for example, a traffic service may offer less than 1 percent of GPS data at night, since at night, for example, traffic congestion is less likely to occur. Another example is a functionality FN performed by the vehicle information system FS in the form of a translator or a translation service, so a non-availability of a language spoken by not so many people can be less sanctioned by a corresponding deviation operation AO than a non-availability of a language spoken by very many people.

Advantageously, the provider or service provider, for example in the device EI, can offer an interface IN for scanning the current quality features.

The service provider can, in case of violation of the features defined in the framework condition plan SC, in particular by the functionality SA, for example the availability and/or the quality, automatically supply the penalty, for example by the payment assigned to it in the value table WT based on the corresponding deviation operation AO. Here, the payment is advantageously made by a cryptocurrency, such as Bitcoin or Ethereum and/or similar.

Furthermore, for example, in the event of a violation of the framework condition plan SC, compensation may be provided depending on the user restriction caused by the actual operation condition. By way of example, depending on the number of GPS data falling below 2 percent, reliable end-of-congestion warning may no longer be possible, but the display of remaining travel times in the vehicle is reasonable as long as more than 1 percent of GPS data is available on a corresponding road segment.

Furthermore, depending on the values W entered in the register RE and/or on further information stored in the framework condition plan SC, a change instruction AA of the framework condition plan SC itself can be executed. By way of example, it is possible that all deviations of the functionality FN, for example in the form of the values W, can be evaluated in the register RE. The information obtained by the evaluation can be used, for example, for future negotiations on a new framework condition plan SC. Furthermore, weaknesses of the respective functionality FN can be uncovered, and thus a root cause determination of the deviation can be done in a particularly advantageous way, since a chronological tracking of the deviations is possible through the register RE.

For new functionalities FN, the respective provider or the device EI of the respective functionality FN can itself offer a framework condition plan SC and store it in the register RE, in particular depending on the consensus agreement.

A further advantage of the method in addition to the automated processing and monitoring is that if, for example, costs have to be paid for requesting the functionality FN, these can be immediately offset against, for example, payments contained in the respective deviation operation AO, which means that no accounting effort is incurred. Furthermore, the method can, for example, be used particularly advantageously in a decentralized manner.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for monitoring a functionality of a vehicle information system of a motor vehicle, the method comprising:
requesting, from a device external to the vehicle via an interface of the vehicle information system, the functionality, wherein the functionality extends a functional scope of the vehicle information system, and wherein a functionality property of the functionality is defined based on a framework condition plan stored in a register;
executing the functionality by the vehicle information system;
detecting an operating state of the functionality of the vehicle information system;
comparing the detected operating state with the functionality property stored in the framework condition plan;
providing, responsive to the comparison indicating a deviation of the operating state from the functionality property recorded in the framework condition plan, at least one value characterising the deviation for the register or at the interface of the vehicle information system.

12. The method of claim 11, wherein the at least one value is transmitted at least, via the interface, to the device and/or a further device, wherein the device and the further device store the register or a register image.

13. The method of claim 12, wherein the at least one value is entered in encrypted form into the register or the register image.

14. The method of claim 13, wherein the entering of the at least one value is dependent upon a consensus agreement.

15. The method of claim 11, wherein the at least one value is compared with a comparison list stored in the framework condition plan, wherein the comparison list includes a deviation operation for the at least one value.

16. The method of claim 15, wherein the deviation operation is performed depending on the at least one value provided.

17. The method of claim 11, wherein a change to the framework condition plan is performed depending on the at least one value entered in the register or depending on change instructions stored in the framework condition plan.

18. A non-transitory computer-readable data medium storing program instructions for monitoring a functionality of a vehicle information system of a motor vehicle, wherein execution of the program instructions an electronic computing device cause the electronic computing device to:
request, from a device external to the vehicle via an interface of the vehicle information system, the functionality, wherein the functionality extends a functional scope of the vehicle information system, and wherein a functionality property of the functionality is defined based on a framework condition plan stored in a register;
execute the functionality by the vehicle information system;
detect an operating state of the functionality of the vehicle information system;
compare the detected operating state with the functionality property stored in the framework condition plan;
provide, responsive to the comparison indicating a deviation of the operating state from the functionality property recorded in the framework condition plan, at least one value characterising the deviation for the register or at the interface of the vehicle information system.
